(19) United States
(12) Patent Application Publication
(10) Pub. No.: US 2021/0403088 A1
(43) Pub. Date: Dec. 30, 2021

(54) STEERING SYSTEM FOR A VEHICLE

(71) Applicant: ZF Friedrichshafen AG, Friedrichshafen (DE)

(72) Inventors: Lutz Eckstein, Aachen (DE); Jan Bavendiek, Roetgen (DE); Jacqueline Weber, Ingolstadt (DE)

(73) Assignee: ZF Friedrichshafen AG, Friedrichshafen (DE)

(21) Appl. No.: 16/753,688

(22) PCT Filed: Sep. 5, 2018
(86) PCT No.: PCT/EP2018/073842

§ 371 Date: Apr. 3, 2020

(30) Foreign Application Priority Data
Oct. 6, 2017 (DE) 10 2017 217 820.5

(51) Int. Cl. B62D 15/02; B60K 37/06; B60K 35/00

(52) U.S. Cl. CPC B62D 15/029; B60K 37/06; B60K 35/00; B62D 15/025; B60K 2370/152; B60K 2370/782; B60K 2370/158; B60K 2370/172; B60K 2370/175; B60K 2370/194; B60K 2370/332; B60K 2370/1537

(57) ABSTRACT

A steering system for a vehicle may include a first actuator and a first display unit. The first actuator may include a first optical element, where when a control unit actuates the first optical element, at least one visual signal is generated to draw the attention of a vehicle driver. When the first optical element is actuated, the first display unit may also be actuated. At least one action request may displayed to the vehicle driver via the at least one display unit.

### TECHNICAL FIELD

The invention relates to a steering system for a vehicle comprising at least one actuator and at least one display element, wherein an optical element is integrated in the at least one actuator. The invention also relates to a method for operating the steering system.

### BACKGROUND

A display control device is described in WO 2017 043 055 A1 that can be mounted on a vehicle, and in which a turning angle of a wheel and a steering angle of a steering wheel are not locked in an automatic steering mode. The display control device comprises an angle detection section that records information regarding a turning angle of the wheel, and a display control section for displaying a steering angle of the steering wheel that is assumed in relation to the information regarding the turning angle of the wheel and recorded by the angle detection section. The display control section controls the steering wheel such that it exhibits the same estimated steering angle as the wheel, wherein a steering angle of the steering wheel can also be displayed in vehicle driver's field of vision.

### BRIEF DESCRIPTION OF THE DRAWINGS

Preferred exemplary embodiments of the invention shall be explained in greater detail below in reference to the drawings, wherein identical or similar elements are provided with the same reference symbols. Therein:

FIG. 1a: shows a schematic illustration of a steering system according to the invention, according to a first exemplary embodiment;

FIG. 1b: shows a schematic illustration of the steering system according to the invention, according to a second exemplary embodiment;

FIG. 2a: shows a schematic illustration of the steering system according to the invention, according to a third exemplary embodiment; and

FIG. 2b: shows a schematic illustration of the steering system according to the invention, according to a fourth exemplary embodiment.

### DETAILED DESCRIPTION

The fundamental object of the invention is to further develop a steering system and a method for a vehicle, wherein actions that are requested, in particular, are displayed in a more intuitively and easily understood manner to a vehicle driver.

This object is achieved by the subject matter of the independent claims 1 and 8.

Preferred embodiments are the subject matter of the dependent claims.

A steering system for a vehicle according to the invention comprises at least one actuator and at least one display unit, wherein an optical element is integrated in the at least one actuator, wherein at least one visual signal can be generated to attract the attention of a vehicle driver when the optical element is actuated by a control unit, wherein when the optical element is actuated, the at least one display unit can also be actuated, wherein at least one action that is needed can be displayed to the vehicle driver by means of the display unit. In other words, when the display unit is actuated by the control unit, the visual signal from the optical element remains active, such that the necessary action is intuitively displayed on the display unit so that it can be easily comprehended. As a result, the vehicle driver has a better understanding of the necessary action, and the reaction time of the vehicle driver as well as the performance of the action are improved.

The at least one visual signal generated by the optical element draws the attention of the vehicle driver to the optical element, wherein the necessary demand for action generated by the control unit is displayed on the display unit in a subsequent step. The visualized action request lies directly in the field of vision of the vehicle driver. By executing the visualized action request, it is advantageously possible to switch from a partially or fully automatic driving mode to a manual driving mode. It is also conceivable for a current driving mode to be maintained, and only individual actions to be displayed, wherein these actions can be executed by the vehicle driver. When the action has been carried out, the current driving mode is then continued.

The visual signal draws the attention of the vehicle driver, wherein both a single visual signal as well as numerous simultaneous or successive, different visual signals, e.g. a blinking of the optical element, may be generated. In other words, the optical element is not lit during a normal driving mode of the vehicle, and first generates a visual signal when an action request is to be indicated to the vehicle driver by actuating the optical element.

The display element is preferably in the form of a display for displaying the requested action in the form of one or more virtual symbols, or as moving or animated symbols. In particular, it is possible to determine which action is to be carried out from the perspective of the vehicle driver.

Preferably, there is a single display unit for displaying all of the action requests that are to be carried out. It is also conceivable to provide a respective display unit for each actuator, if numerous actuators are used. The at least one display unit is located above the actuator according to a preferred embodiment, wherein the position of the display unit can be specific to its application, depending on the size and respective function of the display unit. The display unit can also be located beneath the actuator.

The at least one actuator is preferably a steering wheel, wherein the optical element is located, e.g. at the top of the steering wheel. In other words, the optical element is located on the circumference of the steering wheel and lies directly in the field of vision of the vehicle driver, in order to draw the attention of the vehicle driver with the visual signal.

The at least one actuator is preferably a control lever, wherein the optical element is located, e.g. on an upper section of the control lever. The optical element is located on a surface or in a region that is visible in particular, i.e. in the direct field of vision, for the vehicle driver, but is not covered by the driver's hands when operating the vehicle. The control lever can have a horizontal surface for this, e.g. an upper surface, on which the optical element is located.

According to a preferred exemplary embodiment, the steering system has a first and second control lever and a first and second display unit, wherein each of the two control levers has a dedicated display unit, and wherein each of the two control levers has a respective optical element. The same or different actions can be carried out by means of the two control levers. In other words, the steering system has two actuators that each have a respective optical element, and two display units.

Furthermore, the respective optical elements preferably comprise at least one light source. In particular, at least one LED is used for the optical element, wherein numerous LEDs can also be used, which are placed on the actuator in locations specific to their applications. The invention includes the technical teaching that the optical element comprises at least one display. It is conceivable to design the display as a full color OLED or LCD display for generating the visual signal to the vehicle driver, and to establish a logical link between the actuator and the display unit. The optical element can be shut off when the display unit is actuated. The optical element can also continue to be actuated during the visualization of the action request on the display unit, or it can continue to generate the visual signal.

The at least one actuator preferably comprises a vibrating unit as well, for increasing the awareness of the vehicle driver, which generates a haptic signal for the vehicle driver. The vibrating unit is configured such that the haptic signal is specific to the action. By way of example, pulses can be transmitted to the vehicle driver by the vibrating unit such that the driver is requested to actuate the actuator in a specific direction, toward the haptic pulse that has been perceived. Alternatively, or additionally, it is conceivable that the vehicle driver is given a haptic signal that draws his attention to the display unit.

According to a method according to the invention for operating a steering system in a vehicle, at least in a semi-automated driving mode of the vehicle, a respective optical element integrated in at least one actuator and at least one display unit are actuated by a control unit, wherein the optical element is first actuated by means of the control unit in order to draw the attention of a vehicle driver, wherein the optical element gives the vehicle driver a visual signal, wherein the display unit is subsequently actuated by the control unit in order to display an action request on the display unit to the vehicle driver. In other words, the logical sequence from the visual signal to the action request displayed on the display unit takes place successively, wherein the transition between the visual signal and the display of the action request takes place seamlessly. Alternatively, the continuation of the visual signal to the action request can take place with a visual interruption.

In particular, the vehicle driver is requested by the action request to at least partially assume driving tasks. It is possible to switch from a first to a second driving mode, e.g. a partially automated driving mode to a manual driving mode. It is also possible for the vehicle driver to carry out an action while in a current driving mode, without changing driving modes. In other words, the current driving mode is maintained after completing the necessary action.

The action request is preferably indicated by at least one arrow on the display unit, wherein the at least one arrow points in a necessary direction of rotation for the at least one actuator. In other words, the logical continuation of the visual signal takes place through the arrow on the display unit. The visualized arrow can be displayed as a moving or stationary image, wherein the origin of the arrow moves in the corresponding direction of rotation when the steering angle has been adjusted through an actuation of the actuator. The point of the arrow indicates the necessary actuation angle of the actuator. In other words, a steering wheel is to be rotated in the direction of the arrow until the optical element is aligned with the point of the arrow, or the necessary steering wheel angle has been reached, and the necessary action has thus been completed.

The shape of the arrow follows the course of the movement of the actuator. If the actuator is a steering wheel, the hands of the vehicle move along a circular path when actuating the steering wheel. Accordingly, the arrow is likewise curved. If the actuator is a control lever, the actuation takes place by pivoting the lever. Here as well, the arrow is curved. It is also conceivable, however, to display straight or otherwise shaped arrows on the display unit, that tell the vehicle driver to actuate the steering wheel in a specific direction of rotation.

The action request is also preferably indicated by at least one animated hand on the display unit, wherein the at least one animated hand tells the vehicle driver to at least partially assume a driving task. In particular in the fully automated mode, the vehicle is not actively controlled by the vehicle driver, i.e. through an active actuation of the actuator. In other words, the vehicle driver's hands do not hold the actuator in this case. The vehicle driver is preferably asked by the control unit to assume the respective driving task, in this case the steering of the vehicle. This takes place through the at least one, preferably two, animated hands that are visualized on the display unit. The action request is indicated by the animated hands holding the steering wheel. This is advantageous when using driver assistance systems for reminding the driver, as well as with partially automated vehicles, for requesting that the driving mode be switched from a fully automated to a manual driving mode. The request to hold the steering wheel can also take place through animated arrows on the display unit.

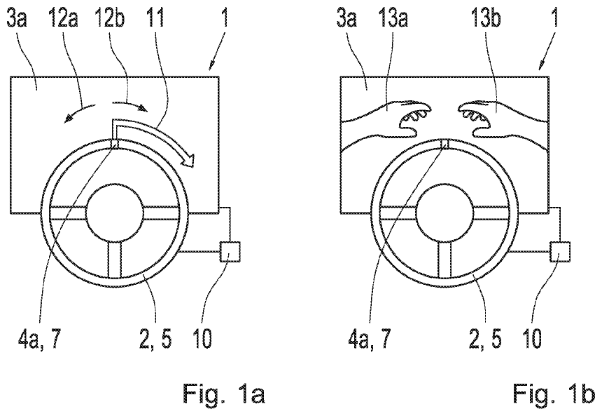

According to FIGS. 1a and 1b, a steering system 1 for a vehicle—not shown herein—comprises an actuator 2, which is in the form of a steering wheel 5, and a display unit 3a. An optical element 4a is integrated in the steering wheel 5, wherein when the optical element 4a is actuated by a control unit 10, at least one visual signal can be generated in order to draw the attention of a vehicle driver—not shown herein. The optical element 4a is located at the top of the steering wheel in the present case, and comprises a light source 7 in the form of an LED, wherein the light source 7 is continuously on while it is actuated by the control unit 10. Alternatively, the light source can also blink 7 when it is actuated by the control unit 10. When the optical element 4a is actuated, the display unit 3a can be actuated in a subsequent step. An action request is displayed to the vehicle driver on the display unit 3a. In other words, the visual signal from the optical element 4a and the action request on the display unit 3a take place in a logical sequence.

FIG. 1a shows a first embodiment of the steering system 1. The action request is displayed as an arrow on the display unit 3a, which requires the vehicle driver to rotate the steering wheel 5 in the direction of the arrow 11, specifically in a second rotational direction 12b. The shape of the arrow 11 is analogous to the curvature of the steering wheel 5. In other words, the shape of the arrow 11 follows the direction of movement for the hands of the vehicle driver when rotating the steering wheel 5. Depending on the driving situation, the arrow 11 can point in the opposite direction—not shown herein—wherein the vehicle driver is then required to rotate the steering wheel 5 in a first rotational direction 12a.

The origin of the arrow 11 is at the height of the optical element 4a, wherein the origin of the arrow 11 moves analogously in relation to the optical element when the steering wheel 5 is rotated. In the present illustration, the arrow 11 becomes longer when the steering wheel 5 is rotated in the first rotational direction 12a, and becomes shorter when the steering wheel 5 is rotated in the second rotational direction 12b. The point of the arrow 11 indicates the point defined by the control unit 10, starting at which a driving task can be assumed by the vehicle driver. In other words, when the necessary steering angle has been reached, the action request has been fulfilled, such that, e.g., it is possible to continue in a normal driving mode, or to switch from a first driving mode to a second driving mode.

According to FIG. 1b, the action request according to a second embodiment is that the vehicle driver is required, in particular in a partially automated driving mode, to assume control of the vehicle, and to hold onto the steering wheel 5 with his hands again. This action request is indicated by two animated hands 13a, 13b on the display unit 3a. The action request comprises, in particular, the animated hands 13a, 13b holding the steering wheel 5 in an animated movement form the perspective of the vehicle driver. Alternatively, the animated hands can also be just symbolic and stationary, for requesting that the vehicle driver hold the steering wheel 5. Alternatively, just one hand 13a can be shown on the display unit 3a.

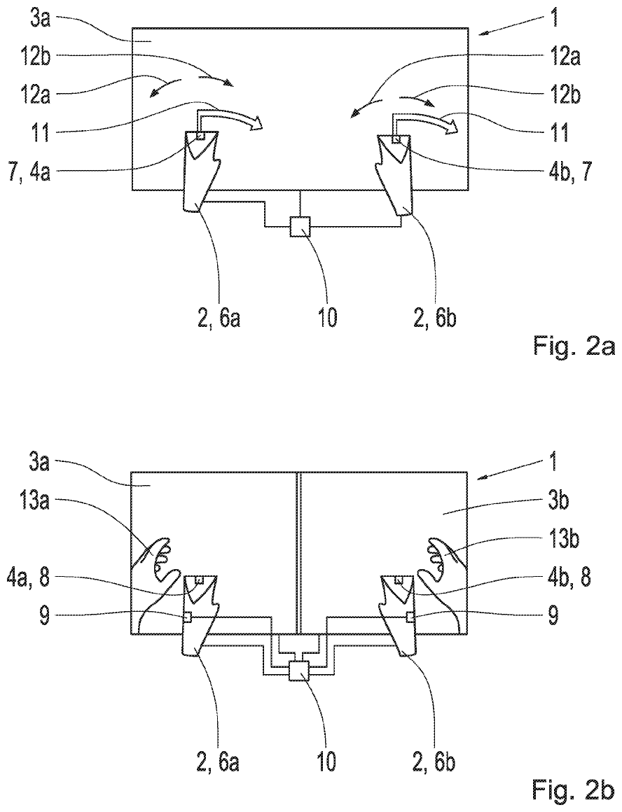

According to FIGS. 2a and 2b, the steering system 1 comprises two actuators 2, specifically a first and second control lever 6a, 6b. An optical element 4a, 4b is integrated in each of the control levers 6a, 6b, wherein at least one visual signal for attracting the attention of the vehicle driver can be generated by a control unit 10 when one of the optical elements 4a, 4b is actuated. The optical elements 4a, 4b can generate the same or different visual signals in this case. Furthermore, the visual signals can be successive. In the present case, the two optical elements 4a, 4b are located on an upper section, i.e. an upper surface, of the respective control levers 6a, 6b. It is advantageous that the optical elements 4a, 4b are always within the field of vision of the vehicle driver, even when the vehicle driver is holding the control levers 6a, 6b with his hands.

A third embodiment of the steering system is shown in FIG. 2a. In the present case, the optical elements 4a, 4b comprise a respective LED light source 7, wherein the light source 7 is continuously on when it is actuated by the control unit 10. Alternatively, the light source 7 can also blink when it is actuated. When the optical elements 4a, 4b are actuated, the display unit 3a is actuated in a subsequent step, resulting in a logical continuation of the visual signal. An action request is displayed to the vehicle driver on the display unit 3a that corresponds to the action request in FIG. 1a. Each of the two control levers 6a, 6b has a respective arrow 11 that tells the vehicle driver to pivot the control levers 6a, 6b in the direction of the arrow 11. These control levers can be pivoted in either a first or second direction of rotation 12a, 12b, depending on the driving situation. The shape of the arrow 11 indicates the direction of movement for the hands of the vehicle driver that are holding the control levers 6a, 6b, thus simplifying understanding of the action request for the vehicle driver.

A fourth embodiment of the steering system 1 is shown in FIG. 2b. In the present case, the steering system 1 has a first and second display unit 3a, 3b, in addition to the two control levers 6a, 6b, wherein each of the control levers 6a, 6b has a dedicated display unit 3a, 3b. The respective optical elements 4a, 4b of the two control levers 6a, 6b comprise displays 8, which are provided for generating the visual signal for drawing the attention of the vehicle driver. The displays 8 for the respective optical elements 4a, 4b can be full color OLED or LCD displays, and they can generate the same or different visual signals. The two display units 3a, 3b collectively visualize an action request for the vehicle driver. Alternatively, each of the display units 3a, 3b can display a respective action request for the vehicle driver. As a result, it is possible to show a first action request on the first display unit 3a, and a second action request on the second display unit 3b by means of the control unit 10. In other words, two different actions can be carried out by means of the two control levers 6a, 6b. The present action request corresponds to the action request in FIG. 1b, wherein a first animated hand 13a is visualized with the first display unit 3a, and a second animated hand 13b is visualized with the second display unit 3b.

The two control levers 6a, 6b also have a vibrating unit 9 for increasing the awareness of the vehicle driver, in order to also generate a haptic signal for the vehicle driver, in addition to the visual signal of the optical elements 4a, 4b.

The invention is not limited to the exemplary embodiments above. It is conceivable, for example, to combine the action request in the first embodiment with the second embodiment and the third embodiment with the fourth embodiment. Furthermore, a vibrating unit can be integrated in each of the first, second or third embodiments described above. Further possibilities can be derived in particular from the description.

### REFERENCE SYMBOLS

1 steering system
2 actuator
3a first display unit
3b second display unit
4a first optical element
4b second optical element
5 steering wheel
6a first control lever
6b second control lever
7 light source
8 display
9 vibrating unit
10 control unit
11 arrow
12a first direction of rotation
12b second direction of rotation
13a first hand
13b second hand

1. A steering system for a vehicle, comprising;
at least one actuator; and
at least one display element,
wherein a first optical element is integrated in the at least one actuator,
wherein when a control unit actuates the first optical element, at least one visual signal is generated to draw the attention of a vehicle driver,
wherein when the first optical element is actuated, the at least one display unit is also actuated, and
wherein at least one action request is displayed to the vehicle driver via the at least one display unit.

2. The steering system according to claim 1, wherein the at least one actuator is a steering wheel, and wherein the first optical element is located on the steering wheel.

3. The steering system according to claim 1, wherein the at least one actuator is a control lever, and wherein the first optical element is located on a section of the control lever.

4. The steering system according to claim 1, wherein the steering system comprises a first control lever and a second control lever, wherein a first display unit of the at least one display unit is dedicated to the first control lever and a second display unit of the at least one display unit is dedicated to the second control lever, and wherein the first optical element is included on the first control lever and a second optical element is included on the second control lever.

5. The steering system according to claim 4, wherein the first optical element and the second optical element each comprise at least one light source.

6. The steering system according to claim 4, wherein the first optical element and the second optical element each comprise at least one display.

7. The steering system according to claim 1, the at least one actuator includes a vibrating unit, and wherein the vibrating unit generates a haptic signal for increasing the awareness of the vehicle driver.

8. (canceled)

9. (canceled)

10. (canceled)

11. A steering system for a vehicle, comprising:
a first actuator; and
a first display unit,
wherein the first actuator includes a first optical element,
wherein when a control unit actuates the first optical element, at least one visual signal is generated to draw the attention of a vehicle driver,
wherein when the first optical element is actuated, the first display unit is also actuated, and
wherein at least one action request is displayed to the vehicle driver via the first display unit.

12. The steering system according to claim 11, wherein the first actuator is a steering wheel, and wherein the first optical element is located on the steering wheel.

13. The steering system according to claim 11, wherein the first actuator is a control lever, and wherein the first optical element is located on a section of the control lever.

14. The steering system according to claim 11, further comprising a first control lever and a second control lever, wherein a first display unit of the first display unit is dedicated to the first control lever and a second display unit of the first display unit is dedicated to the second control lever, and wherein the first optical element is included on the first control lever and a second optical element is included on the second control lever.

15. The steering system according to claim 14, wherein the first optical element and the second optical element each comprise at least one light source.

16. The steering system according to claim 14, wherein the first optical element and the second optical element each comprise at least one display.

17. The steering system according to claim 11, wherein the at least one actuator includes a vibrating unit, and wherein the vibrating unit generates a haptic signal for increasing the awareness of the vehicle driver.

18. A method, the method comprising:
forming a steering system for a vehicle, wherein the steering system comprises the following:
at least one actuator; and
at least one display element,
wherein a first optical element is integrated in the at least one actuator,
wherein when a control unit actuates the first optical element, at least one visual signal is generated to draw the attention of a vehicle driver,
wherein when the first optical element is actuated, the at least one display unit is also actuated, and
wherein at least one action request is displayed to the vehicle driver via the at least one display unit.

19. The method according to claim 18, wherein the at least one actuator is a steering wheel, and wherein the first optical element is located on the steering wheel.

20. The method according to claim 19, wherein the at least one actuator is a control lever, and wherein the first optical element is located on a section of the control lever.

21. The method of claim 18, wherein the steering system further comprises a first control lever and a second control lever, wherein a first display unit of the first display unit is dedicated to the first control lever and a second display unit of the first display unit is dedicated to the second control lever, and wherein the first optical element is included on the first control lever and a second optical element is included on the second control lever.

22. The method according to claim 21, wherein the first optical element and the second optical element each comprise at least one light source.

23. The method according to claim 22, wherein the first optical element and the second optical element each comprise at least one display.
